(19) United States
(12) Patent Application Publication
(10) Pub. No.: US 2004/0084619 A1
(43) Pub. Date: May 6, 2004

(54) Method and an apparatus for determining the dimension of a feature by varying a resolution determining parameter

(76) Inventors: Carsten Hartig, Meerane (DE); Gunter Grasshoff, Radebeul (DE)

Correspondence Address: J. Mike Amerson, Williams, Morgan & Amerson, P.C., Suite 1100, 10333 Richmond, Houston, TX, 77042, US

(21) Appl. No.: 10/420,288

(22) Filed: Apr. 22, 2003

(30) Foreign Application Priority Data
Oct. 31, 2002 (DE) 102 50 893.3

(51) Int. Cl. G21K 7/00; G01N 23/00

(52) U.S. Cl. 250/307

(57) ABSTRACT

A metrology tool, such as a scanning electron microscope, includes a control unit that calculates the dimension of a feature on the basis of a plurality of measurement results obtained with different resolution conditions. A mathematical function may be determined that represents the measurement results and an extreme value of the function may be calculated to obtain a final dimension of the feature. The actual dimension may thus be estimated more precisely than by a single measurement with an automatically determined “optimum” resolution of the metrology tool.

### BACKGROUND OF THE INVENTION

1. Field of the Invention

Generally, the present invention relates to metrology in the manufacturing of micro-structures, such as integrated circuits, and, more particularly, to the measurement of the dimensions of microstructure features by means of metrology tools, such as a scanning electron microscope (SEM), which allow the determination of critical dimensions (CD) of the microstructures.

2. Description of the Related Art

In manufacturing microstructures such as integrated circuits, micromechanical devices, opto-electronic components and the like, device features such as circuit elements are typically formed on an appropriate substrate by patterning the surface portions of one or more material layers previously formed on the substrate. Since the dimensions, i.e., the length, width and height, of individual features are steadily decreasing to enhance performance and improve cost effectiveness, these dimensions have to be maintained within tightly-set tolerances in order to guarantee the required functionality of the completed device. Usually, a large number of process steps have to be carried out for completing a microstructure, and thus the dimensions of the features during the various manufacturing stages have to be thoroughly monitored to maintain process quality and to avoid further cost-intensive process steps owing to process tools that fail to meet the specifications in an early manufacturing stage. For example, in highly sophisticated CMOS devices, the gate electrode, which may be considered as a polysilicon line formed on a thin gate insulation layer, is an extremely critical feature of a field effect transistor and significantly influences the characteristics thereof. Consequently, the size and shape of the gate electrode has to be precisely controlled to provide the required transistor properties. Thus, great efforts are being made to steadily monitor the dimensions of the gate electrode.

Device features are commonly formed by transferring a specified pattern from a photomask or reticle onto a radiation-sensitive photoresist material by optical imaging systems with subsequent sophisticated resist treating and development procedures to obtain a resist mask having dimensions significantly less than the optical resolution of the imaging system. It is, therefore, of great importance to precisely control and monitor the dimensions of these resist features, as these features that determine the dimensions of the actual device features may be “reworked” upon detecting a deviation from the process specification.

A frequently used metrology tool for determining feature sizes in a non-destructive manner is the scanning electron microscope (SEM), which is able, due to the short wave-length of the electrons, to resolve device features having dimensions, also referred to as critical dimensions (CD), in the deep sub-micron domain. Basically, in using an SEM, electrons emitted from an electron source are focused onto a small spot of the substrate via a beam shaping system. Secondary radiation generated by the incident electrons is then detected and appropriately displayed. Although an SEM exhibits a superior resolution compared to optical measurement tools, the accuracy of the measurement results strongly depends on the capability of correctly adjusting the focus of the SEM, i.e., correctly adjusting one or more tool parameters, such as the lens current of a magnetic lens, the acceleration voltage and the like. For instance, in scanning a device feature such as a line, an electron beam that is not set to the optimized focus condition may result in an increased measurement value, whereas scanning a trench with a slightly defocused electron beam may lead to an underestimation of the actual trench width. Since the ever-decreasing features sizes of sophisticated microstructures pose very strict constraints on the controllability of critical dimensions, the measurement tolerances of the metrology tools become even more restricted as the tightly set critical dimensions have to be monitored in a reproducible and reliable manner.

In some conventional SEM tools, the focus is set and checked manually by an operator. However, this technique is not sufficiently sensitive as the tool setting is extremely dependent on the skill and experience of the operator. In other conventional methods for focusing an SEM tool, an optical microscope may be used to map the position in the depth direction of device features and to relate the obtained depth position to one or more apparatus parameters of the SEM tool to thereby obtain focus conditions for the subsequent measurement of the features. Due to the many variables involved in determining an appropriate focus depth, these methods turn out to be hardly reproducible and thus may not adequately provide for the required metrology “budget.”

In view of the problems outlined above, SEM tools have recently been introduced that are adapted to carry out dimension measurements in a substantially completely automatic manner. That is, these SEM tools repeat for each measurement target a process sequence including pattern recognition, automatically focusing the tool and measuring the pattern under consideration. With shrinking features sizes, however, automatically determining optimum resolution conditions becomes more and more challenging as, for example, the beam shaping system of modern SEM tools is designed to give an optimum resolution with lower and lower focus depth, while at the same time features with steadily reduced sizes produce less signal for the automated focus algorithms implemented in these tools. Consequently, if any routine for determining an optimum resolution of an inspection tool is carried out, the obtained setting may include a certain degree of uncertainty that is determined by the specific inspection tool used and the operational behavior, for example, the implemented focus-finding algorithms, and the current conditions thereof. Thus, although modern state of the art inspection tools allow improved precision and throughput by automatic determination of appropriate focus and resolution conditions, the demand for tightly-set measurement tolerances required for features sizes for 0.08 μm and even less may not be satisfactorily met by presently available inspection tools.

In view of the above problems, it would be desirable to provide a technique that reliably determines the dimensions of features in the deep sub-micron regime with a minimal variation.

### SUMMARY OF THE INVENTION

Generally, the present invention is directed to an apparatus and method for determining the dimension of a feature, wherein a plurality of resolution or focus conditions are selected and the dimension of the feature is measured for each of these conditions. Based on these measurement values, the actual dimension of the feature is then calculated, whereby information on the type of feature to be measured is taken into account and/or an algorithm for finding an “optimum” resolution or focus of the inspection tool is employed for one of the plurality of measurements. It is noted that in the specification the terms “resolution” and “focus” may be interchanged for metrology tools having a beam shaping system that allows an active control of a probing beam emitted by the metrology tool. For example, an SEM is able to control the characteristics of an electron beam emitted, wherein, for instance, a size of the beam waist may be considered as a focus determining, and thus a resolution determining, parameter so that this focus parameter may describe the tool's capability to precisely obtain a minimum dimension. In other applications, the term focus may be considered inappropriate for describing this capability and therefore the term resolution is used as a generic term for generally quantifying the capability of determining a minimum feature size in a single measurement cycle.

According to one illustrative embodiment of the present invention, a method of determining a dimension of a feature comprises providing an inspection tool having a resolution adjustable by at least one resolution parameter. A plurality of values of at least one resolution parameter are then determined and the dimension is measured for different resolutions to obtain a plurality of measurement results, wherein each resolution is represented by a respective one of the values. Additionally, a final dimension of the feature is calculated on the basis of the plurality of measurement results and on the basis of information of the feature to be measured.

According to another illustrative embodiment of the present invention, a method of determining a dimension of a feature comprises the provision of an inspection tool having a resolution that is adjustable by at least one resolution parameter. A first value of at least one resolution parameter is determined such that the resolution meets a predefined resolution criterion. Then, the dimension is measured with the first value to obtain a first measurement result. Thereafter, the dimension is measured with a second value of at least one resolution parameter that is greater than the first value in order to obtain a second measurement result. Additionally, the dimension is measured with a third value of at least one resolution parameter that is less than the first value to obtain a third measurement result, and subsequently a final dimension of the feature is estimated on the basis of the first, second and third measurement results.

In a further illustrative embodiment of the present invention, a method of determining a dimension of the feature comprises the provision of an inspection tool having a resolution that is adjustable by at least one resolution parameter. A plurality of values for at least one resolution parameter are determined and the dimension is measured with each of the plurality of values to obtain respective measurement results. Additionally, the measurement results are related to the values by a mathematical function and a final dimension of the feature is calculated by determining a specified characteristic of the mathematical function.

According to a further illustrative embodiment of the present invention, a metrology system comprises a measurement section configured to generate a signal indicative of a surface portion of a workpiece to be measured. Moreover, a resolution adjustment section is provided and is configured to control at least one system parameter to adjust a resolution of the system. A control unit is in communication with the measurement section and the resolution adjustment section, wherein the control unit is configured to select a plurality of parameter values to instruct the resolution adjustment section to set different resolutions and wherein the control unit is further configured to calculate a dimension of a feature formed in the surface portion on the basis of a measurement result for each of the different resolutions.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a metrology system including an SEM and a control unit in accordance with one illustrative embodiment of the present invention;

FIGS. 2a-2b schematically illustrate the effect of a defocused electron beam scanning across a device feature;

FIG. 3 is a graph illustrating a typical result obtained for a CD determination according to one illustrative embodiment;

FIG. 4 is a graph depicting measurement results that may be obtained with a non-optimized resolution finding algorithm; and

FIG. 5 schematically shows a further metrology system including an atomic force microscope (AFM) according to another illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Although the various regions and structures of a semiconductor device are depicted in the drawings as having very precise, sharp configurations and profiles, those skilled in the art recognize that, in reality, these regions and structures are not as precise as indicated in the drawings. Additionally, the relative sizes of the various features and doped regions depicted in the drawings may be exaggerated or reduced as compared to the size of those features or regions on fabricated devices. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As previously noted, decreasing feature sizes and economic demands require manufacturers of microstructures to employ metrology systems for CD measurements ensuring accurate measurement results while providing a high throughput. Automated metrology tools for non-destructive CD measurements may represent extremely complex and expensive tools in a process line, wherein the required process margins are nevertheless very difficult to be met, especially when taking future device generations into consideration. The present invention, therefore, provides for significantly improving measurement accuracy, and thus device utilization, for current and future generations of microstructures by reducing the influence of automated resolution-finding algorithms.

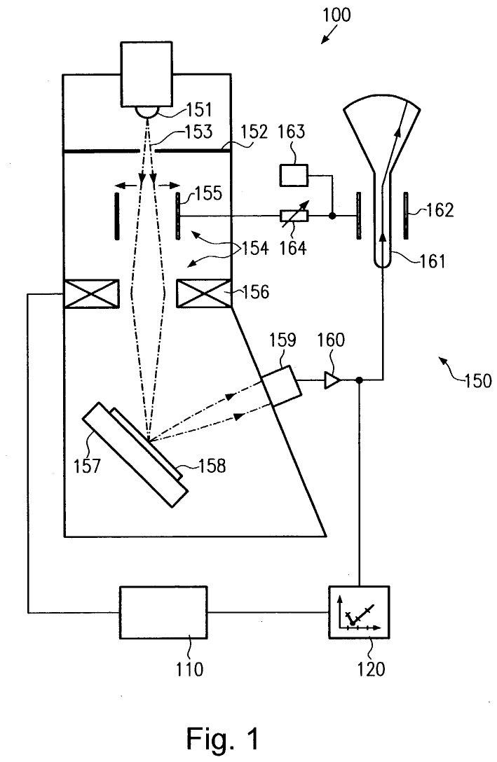

With reference to FIG. 1, a metrology system for automated non-destructive CD measurements in accordance with one illustrative embodiment of the present invention will now be described. In FIG. 1, a metrology system 100 comprises a measurement section 150, a parameter adjustment section 110 connected thereto and a control unit 120 in communication with the measurement section 150 and the parameter adjustment section 110. The measurement section 150 includes a cathode 151 and an anode 152, which are configured and arranged to produce, in operation, an electron beam 153. A beam shaping system 154 includes deflecting elements 155, for example, provided in the form of electrode plates and/or solenoids, and one or more magnetic lenses 156. A support 157 is adapted and arranged to hold a workpiece 158, for example, a semiconductor substrate or a semiconductor chip. For convenience, any means required for loading and unloading the workpiece 158 onto the support 157 are not shown. A detector 159 coupled to an amplifier 160 is positioned to receive a signal from the workpiece 158. A display means 161, such as a cathode ray tube (CRT), is coupled to the amplifier 160 and is further adapted to produce a signal indicative of the signal received by the detector 159 via the amplifier 160. In the case of the CRT 161, deflecting elements 162 may be provided that are coupled via a magnification adjustment element 164 to the beam deflecting elements 155. Moreover, a scan generator 163 is connected to the deflecting elements 155 and 162. It should be noted, however, that the display means 161 represents any appropriate arrangement that allows monitoring and/or recording an output signal provided from the amplifier 160.

Moreover, the control unit 120 is coupled to the amplifier 160 and to the parameter adjustment section 110. Contrary to conventional devices, the control unit 120 is configured to instruct the parameter adjustment section 110 to select various values for one or more tool parameters so that a resolution, for instance the focus, of the measurement section 150 may appropriately be adjusted prior to generating a measurement result.

The operation of the metrology system 100 will now be described. The workpiece 158 is loaded onto the support 157 and the measurement section 150 is evacuated to establish appropriate environmental conditions for generating the electron beam 153.

Thereafter, a typical pattern including one or more features to be measured is identified by, for example, optical means (not shown), or by appropriately adjusting the magnification system 164 to obtain a relatively wide view of the workpiece 158, allowing recognition of the pattern of interest. It should be noted that any image processing means may be provided for this purpose. When the electron beam 153 is used for identifying the target pattern, the control unit 120 advises the parameter adjustment section 110 to appropriately control one or more tool parameters to obtain a suitable signal from the detector 159 and the amplifier 160 that is suitable for the pattern recognition. For instance, an acceleration voltage supplied between the cathode 151 and the anode 152 and/or a current supplied to one or more magnetic lenses 156 may be selected in accordance with predefined default values to produce signals allowing the identification of the target pattern.

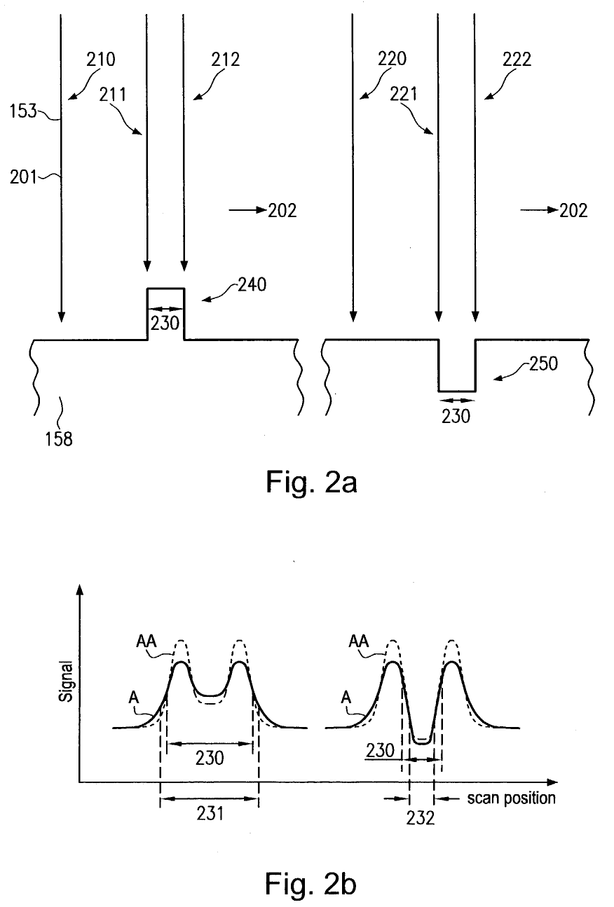

Once the target pattern is identified, the control unit 120 instructs the parameter adjustment section 110 to vary the value of at least one parameter so that a plurality of different resolution conditions, i.e., in the present case different focus conditions, are established. Then, for each of the different values, a scan operation is initiated by operating the scan generator 163 so that the electron beam 153 shaped by the presently valid parameter value is scanned across a feature to be measured. The electrons of the beam 153 impinging on the feature create a plurality of secondary signals, such as secondary electrons released from the material of the feature, electrons scattered by the feature material, X-rays created by the absorption of primary electrons, the scattering of primary electrons, and/or the emission of secondary electrons, and the like. At least one of these signals is detected by the detector 159. The corresponding signal output by the detector 159 and amplified by the amplifier 160 is fed to the control unit 120, which produces, after completion of the scan operation, a first measurement result of the dimension of the feature. This procedure is repeated for each of the plurality of different parameter values to obtain second, third and possibly more measurement results, wherein each measurement result corresponds to a different resolution condition, i.e., focus condition, of the measurement section 150. Typically, the measurement result for the dimension of the feature depends on the resolution condition, i.e., the focus condition, used for obtaining the measurement result, as will be detailed with reference to FIGS. 2a-2b.

In FIG. 2a, the workpiece 158 includes a feature 240 in the form of a line, such as a resist line, having a lateral dimension 230, which will also be considered as the critical dimension. A feature 250 in the form of a trench having a critical dimension 230 is illustrated on the right-hand side of FIG. 2a. At the left side of FIG. 2a, the electron beam 153 is depicted as being shaped by the beam-shaping system 154 so as to have a focus 201 in the form of a beam waist (not shown), the size of which substantially determines the imaging characteristics of the metrology tool 100. Thus, the electron beam 153 is defocused. The electron beam 153 is shown for three different scan positions 210, 211 and 212 for a scan motion as indicated by arrow 202. Similarly, three scan positions 220, 221 and 222 are shown on the right side of FIG. 2a during measurement of the critical dimension 230 of the trench 250.

FIG. 2b. shows a graph that depicts a qualitative result of scanning the line 240 and the trench 250, respectively. The vertical axis represents the signal that may be obtained from the amplifier 160 and the horizontal axis represents the scan position. Curves A and AA, may qualitatively describe the behavior of the output signal from amplifier 160 for a defocused electron beam (curve A) and an “ideally” focused electron beam (curve AA), respectively, when scanning the line 240. Curves B and BB may qualitatively describe the behavior of the output signal from amplifier 160 for a defocused electron beam (curve B) and an “ideally” focused electron beam (curve BB) when scanning the trench 250. Typically, the electron beam 153 at the position 210 may produce a relatively weak “background” signal upon interaction with the horizontal portions of the workpiece 158. The edges of the line 240 extending from the surface of the workpiece 158 will then generate a significant increase in the signal caused by an increased emission of secondary electrons due to the altered topography upon incidence of primary electrons of the beam 153. In FIG. 2a, it is assumed that the focus 210, i.e., the beam waist, is not optimal (curves A, B). Due to the defocused condition, the electron beam 153 will, therefore, produce a broader signal shape compared to an optimally adjusted focus (curve AA). Accordingly, the corresponding recognition algorithm implemented in control unit 120 may overestimate the critical dimension 230 in producing a measurement result 231.

On the other hand, for the same focus conditions, the relatively low “background” signal generated at the scan position 220 may be decreased by crossing the edges of the trench 250, as, for example, indicated by scan position 221, when a portion of the beam interacts with the edge area of the trench 250, whereas a reduced signal attenuation is obtained in positions when substantially the entire electron beam 153 impinges on the bottom of the trench 250. Again, the defocused condition (curve B) will lead to a broader signal shape than an “ideally” focused beam (curve BB) so that, for a signal attenuation, the critical dimension may be underestimated to produce a reduced measurement result 232. Hence, the measurement results 231 and 232 may sensitively depend on the condition for setting the focus 210.

Therefore, in the present invention, a plurality of different parameter values are selected to obtain different resolutions, i.e., focus conditions, wherein the measurement results, such as results 231 or 232, are used to calculate a final or “true” critical dimension, thereby minimizing the measurement budget of the metrology system 100. As previously noted, in modern SEM metrology tools, such as the tool 100, automated focus finding algorithms are used prior to each of a plurality of measurement cycles in an attempt to obtain accurate measurements. It is thus evident that the measurement results depend on the efficiency of the algorithm employed.

Therefore, in one particular embodiment of the present invention, the resolution or focus obtained by such an automated algorithm is used only as an initial tool setting for receiving a first measurement result and the resolution is varied such that at least one parameter defining the resolution, i.e., the focus condition, such as the current to the magnetic lens 156 and/or the acceleration voltage, is set to a value above the value previously found by the algorithm. Then, a corresponding critical dimension is measured, yielding a measurement result other than the first measurement result due to the higher degree of defocusing, provided that the focus finding algorithm is quite effective. Thereafter, the parameter value is set less than the value previously found by the algorithm and the corresponding critical dimension is measured.

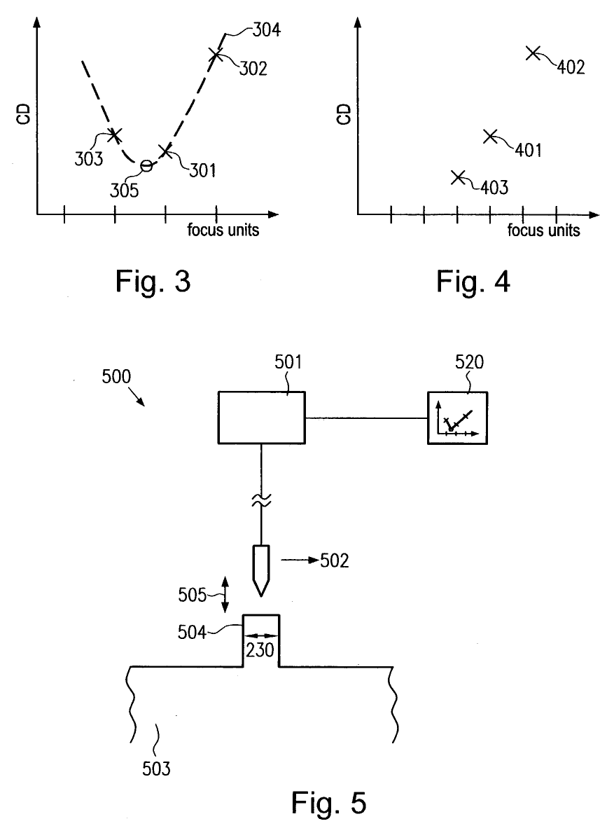

FIG. 3 shows the corresponding measurement results for a line element, such as the line element 240, for three different focus settings. In FIG. 3, the horizontal axis represents discrete parameter values, denoted as focus units, for at least one tool parameter affecting the tool focus, and the vertical axis represents the critical dimension of the line 240. Depending on the efficiency of the algorithm for finding an “optimum” resolution condition, which may be accomplished by varying a tool parameter in a step-like manner and determining, for example, the point of a maximum change in contrast during scanning of the workpiece 158 along a single scan line, the measurement result representing the “optimum” parameter setting and represented by 301 may yield a critical dimension that is within a relatively small range of the actual critical dimension. Since, due to throughput consideration, a measurement for a large number of workpieces 158 is preferably carried out in a fully automated manner, the quality of the implemented algorithm for finding the “optimum” resolution condition may not, however, be effectively monitored and evaluated during operation of the metrology tool 100. The second measurement carried out with a parameter setting that is, for example, one focus unit higher than the initial focus setting may result in the measurement value 302 that is significantly larger than the measurement result 301. As previously noted with reference to FIGS. 2a-2b, measurements of line elements will typically result in overestimated dimensions with an increasing deviation from an ideal focus position. The third measurement carried out with a parameter setting that is, for example, one unit below the initial resolution condition may result in the measurement result 303 that also exceeds the measurement result 301.

Next, the control unit 120 calculates a final critical dimension 405 on the basis of the measurement results 301, 302 and 303 and/or on the basis of information about the feature 240. That is, since the feature 240 is a line, the control unit 120 expects an increase of the critical dimension with a deterioration of the resolution, i.e., with an increasing deviation from the ideal focus position. On the other hand, if the information about the feature advises the control unit 120 that a different behavior is to be expected, that is, if the feature to be measured is the trench 250, the control unit expects a decreasing measurement result with an increasing deviation from the ideal focus setting. The control unit 120 then determines a mathematical function representing the measurement results 301, 302 and 303 and determines on the basis of the mathematical function a final critical dimension that more precisely represents the actual dimension of the feature to be measured.

In one embodiment, the function 304 may be a predefined type of function, for example, a parabola or a polynomial of higher order, and the control unit 120 is adapted to determine the coefficients of the function 304 and to calculate an extreme value and/or a range containing an extreme value to obtain the final dimension. In the example shown in FIG. 3, the function 304 represents a parabola wherein a minimum 305 is considered as the final dimension of the line 240. For the trench 250, the function 304 may be represented by a parabola opened downwardly so that the extreme value is a maximum. It should be noted that the function 304 may be represented by any appropriate mathematical expression that allows the identification of a specified characteristic of the function 304, representing the final critical dimension. Thus, the function 304 may not necessarily be expressed by a contiguous analytic expression, but may also be represented by a plurality of discrete points or a combination of pairs of variates and analytic expressions, and the like.

In one embodiment, the mathematical function 304 may be represented by discrete pairs of variates representing a relationship between at least one resolution determining parameter value and the measured dimension. For instance, the relationship between at least one parameter and the measured critical dimension may be established on the basis of calibration measurements previously carried out on product or test workpieces, and these pairs of variates themselves may be used as the mathematical function to determine the final dimension, or the pairs of variates may be used to establish the mathematical function. For example, a fit curve may be determined and the final dimension may be calculated on the basis of the fit curve and the measurement results. In certain cases, it may be sufficient to merely carry out one measurement with a specified resolution condition, for example, the focus setting as obtained by an automated algorithm, to determine on the basis of the fit curve and the measurement result the final dimension. To this end, the measurement result obtained with the specified focus condition is compared with the respective point or range of the fit curve and the resulting offset is determined. The respective final dimension may then be determined by adding the offset to the final dimension of the calibration curve. Additional measurements with different focus settings may be carried out to estimate whether substantially the same final dimension is obtained for all measurements. If one or more of the results are outside of a specified range, i.e., do not match the calibration dimension, an invalid tool status may be indicated to an operator. In this case, a precise recalibration of the metrology system 100 may be carried out. Instead of the fit curve, the plurality of calibration measurement results may directly be used as the mathematical function, and the result of the current measurement may be compared with the corresponding calibration result. Preferably, at least one focus determining parameter is set during the measurement to a value that is closest to the “ideal” focus condition. For example, if the curve 304 has been determined in advance by corresponding calibration measurements—the results 303, 302, 301 may be considered as calibration results—the focus condition corresponding to 301 could be used for the actual measurements.

In other embodiments, the relationship between the critical dimension and the resolution of the metrology tool 100 may be established by a theoretical model, possibly in combination with calibration measurement values. For instance, the interaction of the electron beam 153 with a specified feature, such as the line 240 or the trench 250, may be calculated for a plurality of different dimensions and resolution conditions, possibly on the basis of respective calibration measurements for these dimensions of the specified features. A corresponding set of model curves may then be compared in an actual measurement process with a plurality of measurement results to determine which curve, and, thus, which final dimension, matches the measurement results for differently set resolution conditions. The embodiments using calibration measurements and, in particular, the embodiments including a model-based fit curve for calculating the final dimension, may either provide an increased throughput, as a minimum number of actual measurement cycles may be sufficient, or they may allow the final dimension to be obtained without relying too extensively on an automated focus finding algorithm or even without performing a focus finding algorithm.

In further embodiments, measurement results may be obtained as described with reference to FIG. 3 and the control unit 120 may be configured to immediately fit a curve to the obtained measurement results and to calculate the final dimension on the basis of the individually obtained fit curve by, for example, determining extreme values of the fit curve.

In other embodiments, when an automated algorithm for finding an optimum initial resolution condition is employed, the quality of this algorithm may be evaluated and monitored on the basis of a distance between the initial measurement result, for example, the result 301 in FIG. 3, and the final dimension obtained by calculation. In this way, the focus finding algorithm may be compared in terms of accuracy and robustness during the manufacturing process.

FIG. 4 shows measurement results that may be obtained when no initial focus finding algorithm is used or when the algorithm is considerably “out of tune.” In FIG. 4, a first measurement result 401 may be obtained, for example, by an automated algorithm for a first focus condition, and subsequently a second and a third measurement result 402, 403 are obtained, wherein the measurement results do not enclose a maximum or minimum “actual” dimension. Based on information on the feature to be measured, the control unit 120 may then decide to perform one or more additional measurements, for example, with a focus setting exceeding the value corresponding to the measurement result 402 if a trench is to be measured, or with a focus unit less than that corresponding to the measurement result 403 if a line is to be measured. The final dimension may then be calculated as previously described with reference to FIG. 3. Moreover, if an automated focus finding algorithm is used, the focus setting may be recalibrated so as to obtain a better match of the initial measurement result 401 with the actual dimension for subsequent measurement cycles. Moreover, a measurement sequence yielding measurement results as shown in FIG. 4 may be used to indicate the measurement sequence as invalid when only a fixed number of measurement cycles is compatible with process requirements.

As is well known, exposing the workpiece 158 to the electron beam 153 may affect corresponding portions of the workpiece 158. For instance, the deposition of electrons within non-conductive areas of a feature to be measured gradually charges the area and thus has an increasing influence on the interaction of the incoming electrons 153 with the material to be measured. Moreover, the electron beam 153 may alter the material properties and thus also result in a variation of the interaction characteristics of the electron beam 153 with the material. In particular, exposing a resist feature to the electron beam 153 may lead to a shrinkage of the feature in addition to a charge accumulation so that repeated measurement of substantially the same area may result in different measured dimensions. Although it is typical for parameters such as the amount of beam current, acceleration voltage and the like to be adjusted so that the incident electron beam 153 minimally affects the feature to be measured, in some embodiments it may be advantageous to take the repeated measurement of substantially the same workpiece area into account. For instance, the measurement results, such as the results 302, 303, 402 and 403, may be compensated for the preceding deposition of electrons in the material of the feature to be measured. If the feature is, for example, a resist feature, the energy deposition in the feature may be estimated on the basis of the presently used beam current and the acceleration voltage, as well as on the type of resist employed, and the measurement result may be corrected corresponding to the induced resist shrinkage. Corresponding correction values may also be obtained by experiment in advance and may be accessed by means of a respective lookup table. Similarly, the effect of the charge accumulated on the feature may be calculated or may be determined by experiments in advance so that a corresponding correction of the measurement results for every further measurement may be carried out.

With reference to FIG. 5, a further illustrative embodiment of a metrology tool according to the present invention will now be described. In FIG. 5, a metrology system 500 includes an atomic force microscope (AFM) having a scan/detector unit 501 and a tip 502 which may be scanned across a workpiece 503 with a feature 504 formed thereon. A control unit 520 communicates with the scan/detection unit 501.

In operation, the tip 502 is scanned across the feature 504, as indicated by the arrow, and the charge clouds in the tip 502 interact with the charge clouds on the surface of the feature 504 so that the tip 502 substantially follows the height profile of the feature 504, as indicated by arrow 505. From the signals delivered to the scanning/detection unit 501, the control unit 520 determines a measurement result indicative of a dimension 506 of the feature 504. The resolution of the metrology tool 500 significantly depends on the condition of the tip 502, wherein, for example, a less tapered end portion of the tip 502 may lead to an over-estimation of the dimension 506. Thus, according to the present invention, a tool parameter, such as contour information representing the tip 502, may be changed, possibly together with a further tool parameter related to the tip contour, and corresponding measurements may then be carried out to obtain measurement results for the respective parameter values of the contour information and the further contour related tool parameters. Regarding the computation of the final dimension based on the plurality of measurement results corresponding to different resolution conditions, the same criteria apply as already pointed out with reference to the metrology tool 100.

As a result, the present invention provides significant improvement of the measurement accuracy of metrology tools for measuring minimal dimensions of features, wherein a plurality of measurements are carried out with different resolution conditions, to calculate a corresponding result for the minimum dimension. This may be done in advance, for example, by establishing a corresponding relationship between the selected resolution condition and the measured dimension for a plurality of test or calibration substrates, so that in the actual measurement procedure, only one or a few measurement cycles are required to obtain an accurate actual dimension. In other embodiments, a plurality of measurement cycles is carried out during the actual measurement process and a function is determined for the measurement results to calculate a final dimension with high precision. Moreover, the quality of implemented resolution setting algorithms may be indicated.

It should be noted that although the embodiments described so far refer to a single parameter that controls the resolution condition of a metrology tool, the present invention also applies to a situation in which two or more tool parameters are varied simultaneously to adjust and determine the resolution condition of the metrology tool. For example, if two tool parameters are involved in varying the tool resolution, the plurality of measurement results obtained for the respective pairs of variates of the two tool parameters may be fitted with an appropriate two-dimensional function, and appropriate characteristics of the two-dimensional function may be determined to obtain the final dimension. Similarly, three or more tool parameters may be varied and a corresponding three or more dimensional function may be determined that allows the calculation of the final dimension.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of determining a dimension of a feature, the method comprising:
providing an inspection tool having a resolution adjustable by at least one resolution parameter;
determining a plurality of values of said at least one resolution parameter;
measuring said dimension for different resolutions, each resolution represented by a respective one of said values to obtain a plurality of measurement results; and
calculating a final dimension on the basis of the plurality of measurement results and a characteristic of said feature.

2. The method of claim 1, wherein calculating said final dimension includes determining a mathematical function relating said plurality of measurement results to said plurality of values.

3. The method of claim 2, further comprising calculating an extremum of said mathematical function, said extremum indicating said final dimension.

4. The method of claim 2, wherein said mathematical function is determined by fitting a curve to said plurality of measurement results.

5. The method of claim 2, wherein said mathematical function is obtained on the basis of at least one of a theoretical model of the inspection tool operation and previously obtained measurement results.

6. The method of claim 1, further comprising determining an initial value for said at least one resolution parameter by an automated resolution finding algorithm.

7. The method of claim 6, wherein determining said plurality of values of said at least one resolution parameter includes determining a first value higher than said initial value and a second value less than said initial value.

8. The method of claim 7, further comprising determining a mathematical function substantially representing the measurement results based on said initial, first and second values and calculating said final dimension on the basis of the mathematical function.

9. The method of claim 8, further comprising evaluating said initial value on the basis of a difference between said initial measurement result and said final dimension.

10. The method of claim 8, wherein a measurement process is evaluated on the basis of a comparison of said plurality of measurement results with said mathematical function.

11. The method of claim 1, wherein said inspection tool comprises a scanning electron microscope.

12. The method of claim 11, further comprising compensating one or more of said plurality of measurement results for at least one effect caused by an electron beam of said scanning electron microscope in said feature.

13. The method of claim 1, wherein said characteristic indicates at least the type of feature to be measured.

14. A method of determining a dimension of a feature, the method comprising:
providing an inspection tool having a resolution adjustable by at least one resolution parameter;
determining a first value of said at least one resolution parameter such that resolution meets a predefined resolution criterion;
measuring said dimension with said first value to obtain a first measurement result;
measuring said dimension with a second value greater than said first value to obtain a second measurement result;
measuring said dimension with a third value less than said first value to obtain a third measurement result; and
estimating a final dimension of said feature on the basis of said first, second and third measurement results.

15. The method of claim 14, further including obtaining a mathematical function relating said first, second and third measurement results to said first, second and third values, and estimating the final dimension on the basis of said mathematical function.

16. The method of claim 15, wherein said mathematical function is obtained on the basis of a characteristic of said feature.

17. The method of claim 15, further comprising determining an extremum of said mathematical function and estimating said final dimension on the basis of said extremum.

18. The method of claim 14, further comprising evaluating said predefined resolution criterion by comparing said first measurement result with said final dimension.

19. The method of claim 18, wherein said first value is determined by an automated resolution setting algorithm.

20. The method of claim 15, wherein said mathematical function is used as a calibration function and whereby the method further comprises:
(a) selecting an adjustment value of said at least one resolution parameter on the basis of said calibration function;
(b) measuring the dimension of a second feature with said adjustment value to obtain an actual measurement result; and
(c) determining a final dimension of said second feature on the basis of an offset between said calibration function and said actual measurement result.

21. The method of claim 20, further comprising repeating steps (a)-(c) at least once, whereby said adjustment value is selected differently in each repetition to obtain a plurality of final dimensions of said second feature for a plurality of different tool resolutions.

22. The method of claim 21, further comprising evaluating said resolution criterion on the basis of said plurality of final dimensions of said second feature.

23. The method of claim 14, wherein said inspection tool is a scanning electron microscope.

24. The method of claim 23, further comprising compensating one or more of said plurality of measurement results for at least one effect caused by an electron beam of said scanning electron microscope in said feature.

25. A method of determining a dimension of a feature, the method comprising:
providing an inspection tool having a resolution adjustable by at least one resolution parameter;
determining a plurality of values for said at least one resolution parameter;
measuring said dimension with each of said plurality of values to obtain respective measurement results;
relating said measurement results to said values by a mathematical function; and
calculating a final dimension of said feature by determining a specified characteristic of said mathematical function.

26. The method of claim 25, further comprising calculating an extremum of said mathematical function, said extremum indicating said final dimension.

27. The method of claim 25, wherein said mathematical function is determined by fitting a curve to said plurality of measurement results.

28. The method of claim 25, wherein said mathematical function is obtained on the basis of at least one of a theoretical model of the inspection tool operation and previously obtained measurement results.

29. The method of claim 25, further comprising determining an initial value for said at least one resolution parameter by an automated resolution finding algorithm.

30. The method of claim 29, wherein determining said plurality of values of said at least one resolution parameter includes determining a first value higher than said initial value and a second value less than said initial value.

31. The method of claim 29, further comprising evaluating said initial value on the basis of a difference between said initial measurement result and said final dimension.

32. The method of claim 25, wherein a measurement process is evaluated on the basis of a comparison of said plurality of measurement results with said mathematical function.

33. The method of claim 25, wherein said inspection tool is a scanning electron microscope.

34. The method of claim 33, further comprising compensating one or more of said plurality of measurement results for at least one effect caused by an electron beam of said scanning electron microscope in said feature.

35. The method of claim 25, further comprising calculating said final dimension on the basis of information indicating at least the type of feature to be measured.

36. A metrology system, comprising:
a measurement section configured to generate a signal indicative of a surface portion of a workpiece to be measured;
a resolution adjustment section configured to control at least one system parameter to adjust a resolution of the system; and
a control unit in communication with said measurement section and said resolution adjustment section, said control unit being configured to select a plurality of parameter values for setting different resolutions and to calculate a dimension of a feature formed in said surface portion on the basis of a measurement result for each of said resolutions.

37. The metrology system of claim 36, wherein said measurement section comprises a scanning electron microscope.

38. The metrology system of claim 36, wherein said measurement section comprises an atomic force microscope.
